(19) United States
(12) Patent Application Publication
(10) Pub. No.: US 2016/0214348 A1
(43) Pub. Date: Jul. 28, 2016

(54) Re-adherable Moisture Resistant Sheets

(71) Applicant: Terry M. Louks-Phillips, Vancouver, WA (US)

(72) Inventor: Terry M. Louks-Phillips, Vancouver, WA (US)

(21) Appl. No.: 15/089,567

(22) Filed: Apr. 3, 2016

Related U.S. Application Data
(63) Continuation-in-part of application No. 14/525,427, filed on Nov. 4, 2014, now abandoned.

(51) Int. Cl. B32B 7/06; D21H 27/00; B32B 3/26

(52) U.S. Cl. CPC B32B 7/06; B32B 3/266; D21H 27/00; B32B 2255/00; B32B 2307/7265; B32B 2307/748; B32B 2432/00; B32B 2571/00

(57) ABSTRACT

A product comprises a plurality of sheets of moisture resistant material arranged in a group; e. g., a roll or a stack. Each sheet is detachably attached to a sheet immediately next to it in the group. The sheets exhibit resistance to moisture. Particularly, the sheets exhibit resistance to liquid as well as partial-liquid/partial-solid substances. The sheets also have features making them re-adhereable, or repositionable. Each sheet has a first side and a second side. The first side comprises at least one re-adherable area that allows the sheet to, for multiple times, adhere to a surface and then be removed therefrom; and the second side of each sheet is resistant to moisture such that liquid-containing substance coming into contact with said second side cannot seep through said sheet. Liquid-containing substance includes all kinds of liquid as well as partial-liquid/partial-solid substances.

### CROSS REFERENCE TO RELATED APPLICATIONS

This application is a continuation-in-part of U.S. application Ser. No. 14/525,427 filed Nov. 4, 2014.

### TECHNOLOGY FIELD

The present disclosure relates to re-adherable, or repositionable sheets that are resistant to moisture. The sheets disclosed herein exhibit resistance to moisture. Particularly, the sheets disclosed herein exhibit resistance to liquid as well as partial-liquid/partial-solid substances. The sheets disclosed also have features making them re-adhereable, or repositionable: each individual sheet can adhere to a surface and then be removed therefrom, and then can adhere to either the same surface again or another surface, and then again be removed therefrom. The sheet can withstand such adherence and removal numerous times without losing its other functions such as moisture resistance, and the adherence at each time is not necessarily relating to a same surface; hence, each individual sheet is repositionable and reusable.

For convenience of storage and use, the sheets disclosed herein can form a roll or a stack whereas each sheet in the roll or stack can be detachably attached to a sheet immediately next to it in the roll or stack.

### BACKGROUND

Both at home and at work, when people are manipulating devices and/or materials for completing certain tasks, they often find the need to quickly grab a sheet of paper towel or a cloth towel to put the devices and/or materials on in order to free their hands while keeping their work-space clean.

For example, when a person is cooking in the kitchen, stirring food in a pot with a spoon or ladle, he may often need to set the spoon or ladle on a work surface, most likely a kitchen countertop, so that he can temporarily free his hands to get something else done while not having to leave the spoon or ladle in the pot which may cause the spoon or ladle to become too hot. Having had contact to the food being cooked, the spoon or ladle is now wet, oily, or greasy, or even having food particles stuck on it. Thus, without proper protection or barrier, the kitchen countertop will become wet, sticky, or stained due to the spoon or ladle.

To solve this problem, many people would use a paper towel or a kitchen towel to set the spoon or ladle on in hopes of keeping the kitchen countertop clean. A kitchen towel takes time and effort to launder; thus many people find a paper towel more convenient, as a clean piece of paper towel is usually instantly available.

However, when the spoon or ladle is wet, oily, or greasy, the spoon or ladle placed on the paper towel tends to stick to the paper towel and the moisture—coming from the water, oil and/or grease on the spoon or ladle—will seep through the paper towel to the kitchen countertop. Hence, the kitchen countertop would still become wet, sticky, or stained.

For another example, when a person is painting a piece of furniture with a paint brush, he may sometimes need to set the brush on a work surface, e. g., a part of a floor or a work table, so that he can take a break or free his hands to rearrange the position of the furniture relative to himself. Without proper protection or barrier, the part of the floor or the work table will be made wet, sticky, or stained by the brush.

To solve this problem, many people would use a paper towel or a rag to set the brush on in hopes of keeping the floor or the table clean. A rag is unsatisfactory since it makes the brush dirty; thus a paper towel is more suitable and also convenient since a clean piece of paper towel is usually instantly available.

However, when the brush is set on a piece of paper towel, the wet paint on the brush tends to stick to the paper towel and the moisture—coming from the wet paint on the brush—will seep through the paper towel to the floor or table. Hence, the floor or the table would still become wet, sticky, or stained.

Actually, in daily life and work, people encounter a great number of problems similar to the cooking and painting scenarios depicted above. When trying to solve these problems, people would often resort to paper towels. However, despite the obvious convenience and the wide application of paper towels—a clean piece of paper towel is readily available for any chore—the permeableness of a paper towel to moisture actually makes it an unsuitable solution to many problems like the ones discussed above—some more example given in the below list, which is not exhaustive. Further, due to it permeableness to moisture, paper towels are not suitable for reuse, thus making them an environment-unfriendly product.

TABLE 1

| Environment | Cause/Origin of Problems |
|---|---|
| Kitchen | sanitary spoon rest, spatula rest along with other |
| | cooking or stirring utensils |
| Bathroom | toothbrush, hairbrush, Vaseline, make-up brushes |
| Classroom | arts and crafts, painting |
| Hair/Nail Salon | hair color brushes and combs, acrylic nail application |
| Doctor's Offices/ | needles, samples, tongue depressor, bio hazardous |
| Hospital | materials |
| Veterinary | needles, bodily fluid samples |
| Offices | |
| Pharmacy | sorting pills/avoid cross contamination of medicine |
| Baby needs | nostril suction tools and the like, Q-tips and medicine |
| | applicators |
| Baking | cake decorating tips |
| Hotels | hygiene items in restroom |
| Restaurants | serving, cooking, and stirring tools for restaurant and |
| | bar, drinks in place of cardboard coasters or napkins |
| Beauty counter at | Q-tips and other applicators while trying different |
| department store | make up products |
| Banks | stamps |

Yet another drawback of a paper towel is that it usually does not stay fixed to the surface upon which it is placed. A piece of paper towel is light-weight and it lacks any means for attachment; therefore, it cannot be adhered to, or attached to, stuck to, or fixed to any surface and stay adhered while in use. A piece of paper towel “holding” one or more small or light-weight items may move or drift on the surface owing to an unintentional touch by a person, a blow of wind, etc., and the movement of the paper towel may cause the items to fall off, which is annoying.

Therefore, there is a need for a product which solves the above-mentioned problems related to paper towels, towels, rags, and the like.

The product can solve some or all of the above-mentioned problems by its resistance to moisture. Particularly, the product is resistant to liquid as well as partial-liquid/partial-solid substances, such as but not limited to water, oil, grease, and fat are some typical liquid or partial-liquid/partial-solid substances.

The product may offer convenience similar to that of a roll of paper towels, particularly in that the product can continuously provide clean sheets of material.

The product may offer further advantage of being re-adhereable, or repositionable, so that it is reusable and thus environment-friendly.

The product may embody other features to make it reusable and environment-friendly. Details are presented below.

### SUMMARY

The present disclosure provides a product that comprises a plurality of sheets of moisture resistant material arranged in a group; e. g., a roll or a stack. Each sheet may be detachably attached to a sheet immediately next to it in the group, i. e., the roll or stack. When needed, a sheet can be easily taken off from the group to be used for protecting a certain surface. Thus, as convenient as a roll of paper towels, the product can continuously provide clean, individual sheets of material.

When arranged in a stack, the plurality of sheets of moisture resistant material may be arranged in a spiral bound stack.

Each sheet has a first side and a second side, wherein the first side may comprise at least one re-adherable area that allows the sheet to, for multiple times, adhere to a surface and then be removed therefrom; and the second side of each sheet may be resistant to moisture such that liquid-containing substance coming into contact with said second side cannot seep through said sheet. Liquid-containing substance includes all kinds of liquid as well as partial-liquid/partial-solid substances.

The re-adhereable area may allow each sheet to adhere to a surface, e.g., a work surface that needs protection, and then, when needed, be removed therefrom. With this feature, the sheet can be adhered to, attached to, fixed to, or stuck to the work surface and stay there securely; and, after its usage, the sheet can be taken off from the work surface. After a first removal, the sheet can adhere to a surface again, which can either be the same surface as the first time or another, different surface; and then it can again be removed therefrom. The sheet can withstand such adherence and removal numerous times without losing its main function, moisture resistance. The adherence at each time may not necessarily relate to a same surface or a same part of the surface; hence, each individual sheet may be repositionable and reusable.

Preferably, each sheet of the product may be resistant to oil, fat, and grease. This means, any kind of oil, fat, and grease as well as any mixture or combination thereof that comes into contact with the sheet, and especially the second side of the sheet, cannot seep through the sheet. Being resistance to oil, fat, and grease makes the product especially useful in kitchens, restaurants, and the like; many other facilities will also find this feature useful.

Preferably, each sheet of the product may further be resistant to any one of the following types of liquid: water, tea, coffee, milk, Kool-Aid, alcohol, alcohol drink, juice, soup, sauce, vinegar, soda, hair dye, liquid soap, liquid detergent, dish wash, fingernail polish, urine, blood, glue, lubricant, liquid type topical medicine. It should be noted that this list is not exhaustive; the product can be resistant to many other types of liquid. Any kind of such liquid as well as any mixture or combination thereof that comes into contact with the sheet, and especially the second side of the sheet, cannot seep through the sheet.

Preferably, each sheet of the product may further be resistant to any one of the following types of partial-liquid/partial-solid substance: honey, yogurt, syrup, gravy, gel, jam, glue, sauce, soup, pancake mix, ice-cream, peanut butter, butter, cream, toothpaste, hand soap, medicine, paint, glue, lubricant, ink, frosting, make-up products, acrylic nail mixture, ointment type topical medicine. It should be noted that this list is not exhaustive; the product can be resistant to many other types of partial-liquid/partial-solid substance. Any kind of such substances as well as any mixture or combination thereof that comes into contact with the sheet, and especially the second side of the sheet, cannot seep through the sheet.

Preferably, each sheet of the product may further be resistant to any one of the following types of liquid, partial-liquid/partial-solid substance, or articles that can, during their normal use, bring about liquid or partial-liquid/partial-solid substance:

Things that Drip:
LAUNDRY SOAP, LAUNDRY SOFTENER, LIQUID SOAP, BAR SOAP, TOOTHPASTE, LIQUID VITAMIN FROM EYE DROP DISPENSER, CLEANING SOLUTION, SUPER GLUE, WOOD GLUE, VEG OIL, CORN OIL, CRISCO, SHAMPOO, CONDITIONER, BUG SPRAY, DE ICER LIQUID, SHOUT IT OUT, KETCHUP, MUSTARD, MAYO, RELISH, ONION, CHILI, LIQUID CHEESE, BBQ SAUCE

### Art Stuff:

### COLOR WAX, INK PENS, OIL PAINTS, COLORED PENCILS, WATER COLORS, CHALK, MOLDING CLAY, SCULPTING CLAY, POTTERY, COLORED GLUE, GLUE GLITTER, FINGER PAINTS, CALLIGRAPHY PENS AND INK, ELMERS GLUE, HOT GLUE, FROSTING/PASTRY TIPS, FROSTING BAGS, PUFF PAINTS

### Nail Stuff:

### POLISH ART STICKS, CLIPPERS, TRIMMERS, FILES, SPONGES, DECALS, ACRYLIC POWDER FOR NAILS, BONDING AGENTS, BUFFERS, COTTON BALLS WITH POLISH REMOVER, COTTON WITH ALCOHOL, LOTION

### Baby Supplies:

### NIPPLES, PACIFIERS, NOSE SUCKER, THERMOMETER, RASH OINTMENT, RATTLES, SIPPY CUPS, TOYS, BABY FOOD, BABY SNACKS, DIAPERS, FEEDING SPOONS, BOTTLE BRUSHES, BUBBLES, BREAST PUMP, BOTTLE, LIDS AND RINGS

### Sticky Stuff:

HONEY, GUMMY CANDY, GUM, JAW BREAKERS, COUGH DROPS, WAX FOR EYEBROWS, CINNAMON ROLLS, LIP WAX, SUGAR WAX, PASTE, PEANUT BUTTER, CRYSTALLIZED SUGAR, POP CORN BALLS, CARMEL APPLES, FLY STRIPS, FACIAL SCRUBS, SPIDER TACK, SUCKERS, CANDY, CANDLE WAX, SUGAR & SALT RIMMED GLASSES, LEMONS, ORANGES,

### Smelly Stuff:

### FISH, ONIONS, GARLIC, CLAMS, OYSTERS, SQUID, CRAB, SALAD DRESSING, PANCAKE BATTER, COOKIE BATTER, SAUCES

### Medical Stuff:

### VAPOR RUB, VASELINE, KYJELLY, BEECKERS, EYEDROPERS, LOTIONS, ANTISEPTIC SWABS, TONGUE DEPRESSORS, SUN SCREEN, NEEDLES, MEDICATIONS

The re-adhereable area provided on the first side of each sheet may take various geometric forms. For example, the re-adhereable area may be a strip positioned along an edge of the first side of the sheet; the re-adhereable area may also be a patch having a circular, oval, square, rectangular, triangle, diamond, or another shape and positioned close to an edge of the first side of the sheet or at the center of the first side of the sheet. Other geometric forms of the re-adhereable area are also possible.

The re-adhereable area provided on the first side of each sheet may comprise a group of sub-areas each being re-adhereable. The sub-areas may be separated from each other. Among themselves, the sub-areas may take the same geometric form or different forms.

The re-adhereable area provided on the first side of each sheet may be provided with re-adherable adhesive. When the re-adhereable area is made up of a group of sub-areas, one or more of the sub-areas may be provided with re-adherable adhesive.

The following are examples of re-adherable adhesive which may find application in the sheets according to the present disclosure:

Removable microsphere adhesives: With small spheres, removable microsphere adhesives cling to surface materials (such as but not limited to paper and film face materials) yet reposition easily and remove without a trace.

Pressure sensitive adhesives, for example, acrylate copolymer microspheres: Pressure-sensitive adhesives form a bond by the application of (light) pressure to connect the adhesive with the adherend.

Repositionable glue stick is also an option.

Other kinds of re-adherable adhesives may also be used for the sheets according to the present disclosure.

Preferably, each sheet can be removed from the surface to which it is adhered without leaving residue of the adhesive. The removable microsphere adhesives and pressure sensitive adhesives can facilitate this feature. Using such adhesives for the sheets of the present disclosure, each sheet can be removed from the surface to which it is adhered without leaving any residue, or trace, of the adhesive. This is advantageous as it eliminates, or at least reduces, the cleaning work needed after using the sheet for protecting the surface.

In the product of the present disclosure, each sheet is detachably attached to the sheet immediately next to it in the roll or stack. This kind of attachment may be facilitated by one or more of the following mechanism:
1. The re-adherable area provided on the first side of each sheet may be additionally used for allowing said sheet to, for multiple times, adhere to the sheet immediately next to it and then be removed therefrom.
This mechanism is advantageous as it requires no additional material or processing during the manufacturing of the product and it facilitates reusing of the sheets. For example, when a sheet is lightly used, the user may want to reuse it, the user can “re-adhere” this sheet back onto the roll or stack.
2. One or more perforations may be formed along at least one edge between said sheet and the sheet immediately next to it. The Perforation(s) can form a weakened part of the sheet so that a user can easily detach, separate, or tear a sheet from the product along the perforations.
3. One or more incisions may be formed along at least one edge between said sheet and the sheet immediately next to it. Incision(s) can form a weakened part of the sheet so that a user can easily detach, separate, or tear a sheet from the product along the incision(s).
4. One or more weakened parts other than perforation(s) or incision(s) may be formed along at least one edge between said sheet and the sheet immediately next to it. The weakened part(s) of the sheet allow a user to easily detach, separate, or tear a sheet from the product near or along the weakened part(s).

Preferably, not only the second side of each sheet, but also the first side thereof is resistant to moisture. Hence, any liquid-containing substance coming into contact with the first side cannot seep through said sheet.

Furthermore, the second side of each sheet may also comprise at least one re-adherable area that allows said sheet to, for multiple times, adhere to a surface and then be removed therefrom.

Preferably, the sheets of the product of the present disclosure are made of one or more of the following material: water-proof paper—one example being RevLar water-proof paper; crepe paper, masking tape, Design Vellum, Bristol Vellum, Flat back paper. Many other kinds of liquid-proof paper and liquid-proof paper substitutes are also possible.

Preferably, the sheets of the product of the present disclosure are made of a non-toxic material. This has the advantage that no health-related or environmental issues could arise to affect the people using the sheets or the environment where they are used.

Preferably, the sheets of the product of the present disclosure can be cleaned and/or sterilized; for example, using water, ethanol, etc. This feature encourages the reusing of the sheets and is thus makes the product more environmental friendly.

The sheets according to the present disclosure find application in a great number of areas both at home and in offices. The sheets can find applications in, for example, cooking, food- or drink-preparation, cleaning, laundering, sanitizing, building, repairing, painting, medical, educational, and child-care environment, etc. The sheets can also find application in the various environments as listed in Table 1 above as well as other similar environments.

### BRIEF DESCRIPTION OF THE DRAWINGS

The foregoing and other features and advantages of the present invention will be more readily appreciated as the same become better understood from the following detailed description when taken in conjunction with the accompanying drawings, wherein:

FIG. 1 is a top diagonal view showing a first embodiment of a product comprising a plurality of moisture resistant sheets of material arranged in a roll;

FIG. 2 is a top diagonal view showing a second embodiment of a product comprising a plurality of moisture resistant sheets of material arranged in a stack;

FIGS. 3A, 3B, 3C, 3D, 3E, and 3F are top views showing different embodiments of a sheet with re-adherable area arranged at different places of the sheet;

FIGS. 4A, 4B, 4C, and 4D are top views showing different embodiments of a sheet being detachably attached to the sheet immediately next to it; and

FIG. 5 shows top views of the two sides of a sheet.

### DETAILED DESCRIPTION OF THE PREFERRED EMBODIMENTS

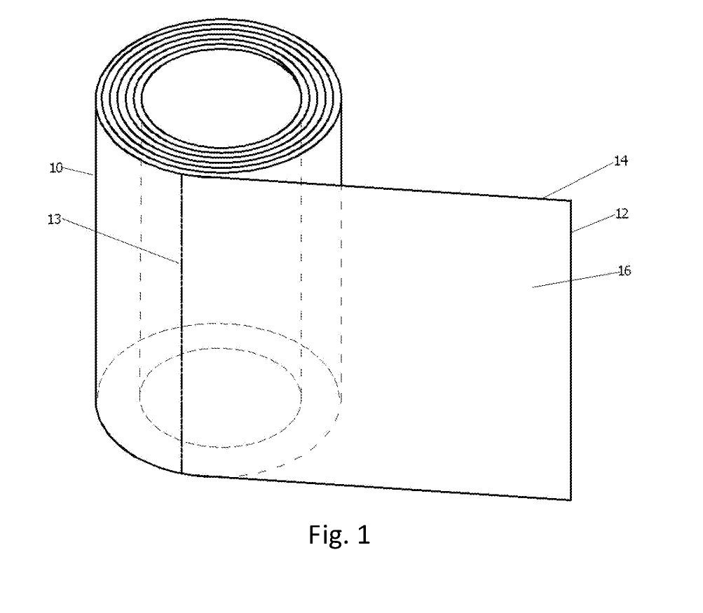

FIG. 1 is a top diagonal view showing a first embodiment of a product comprising a plurality of moisture resistant sheets of material arranged in a roll.

The product is indicated as 10 in FIG. 1. Product 10 comprises a plurality of sheets arranged in a roll. One sheet is indicated as 12. For convenience of explanation, sheet 12 is the first sheet, or the leading sheet, of the roll. Sheet 12 is detachably attached to a sheet immediately next to it in the roll; the detachable attachment between sheet 12 and the sheet immediately next to it is indicated by line 13. The sheets are moisture resistant. Each sheet has a first side and a second side; for example, sheet 12 has a first side 14 and a second side 16. As explained in detail below, the first side of each sheet, e.g., first side 14 of sheet 12, comprises at least one re-adherable area that allows said sheet to, for multiple times, adhere to a surface and then be removed therefrom, and the second side of each sheet, e.g., second side 16 of sheet 12, is resistant to moisture such that liquid-containing substance coming into contact with said second side cannot seep through said sheet; for example, liquid-containing substance coming into contact with second side 16 cannot seep through sheet 12.

The sheets in FIG. 1 are shown to be a rectangular shape. However, the sheets according to the present disclosure can be of any shape, such as but not limited to the following: circle, oval, and any kind of polygon; any other regular shape; and any irregular shape. The sheets can also be of any part of the above regular or irregular shape, such as a part- or half-circle, a part- or half-oval, and the like.

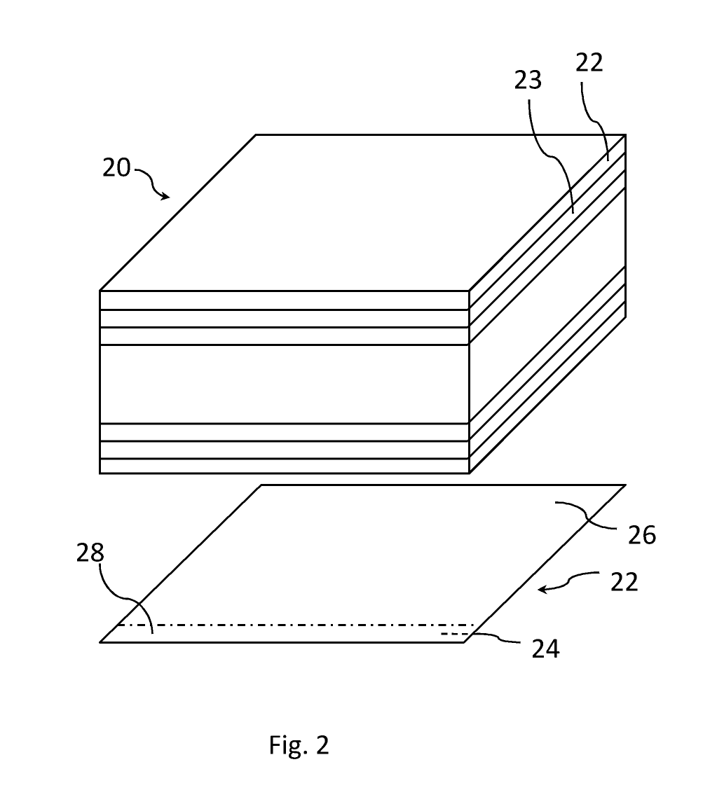

FIG. 2 is a top diagonal view showing a second embodiment of a product comprising a plurality of moisture resistant sheets of material arranged in a stack.

The product is indicated as 20 in FIG. 2. Product 20 comprises a plurality of sheets arranged in a stack. One sheet is indicated as 22 and the sheet immediately next to it is indicated as 23. For convenience of explanation, sheet 22 is the first sheet, or the top sheet, of the stack. Sheet 22 is detachably attached to a sheet immediately next to it in the stack, here sheet 23. The sheets are moisture resistant. Each sheet has a first side and a second side; for example, sheet 12 has a first side 24 and a second side 26. As explained in detail below, the first side of each sheet, e.g., first side 24 of sheet 22, comprises at least one re-adherable area 28 that allows said sheet 22 to, for multiple times, adhere to a surface and then be removed therefrom. In FIG. 2, the second side 26 is shown as the top side of the sheet 22 (that is, second side 26 can be clearly seen) while the first side 24 is shown as the bottom side—hence, not seen by viewers; hence, a border line of the re-adherable area is indicated by dotted line.

The second side of each sheet, e.g., second side 26 of sheet 22, is resistant to moisture such that liquid-containing substance coming into contact with said second side cannot seep through said sheet; for example, liquid-containing substance coming into contact with second side 26 cannot seep through sheet 22.

The sheets in FIG. 2 are shown to be a rectangular shape. However, the sheets according to the present disclosure can be of any shape, such as but not limited to the following: circle, oval, and any kind of polygon; any other regular shape; and any irregular shape. The sheets can also be of any part of the above regular or irregular shape, such as a part- or half-circle, a part- or half-oval, and the like.

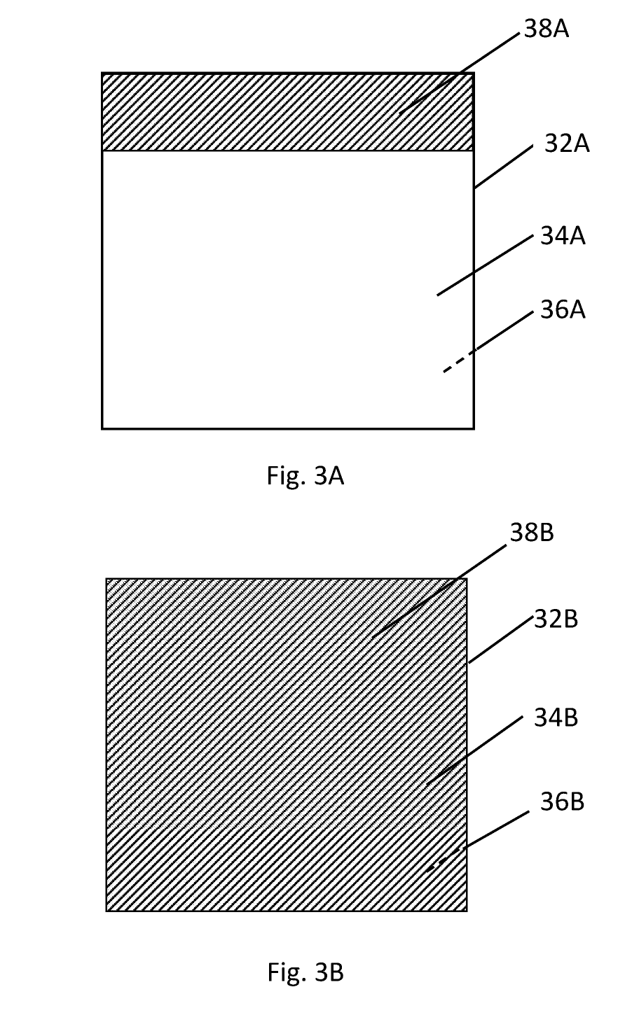

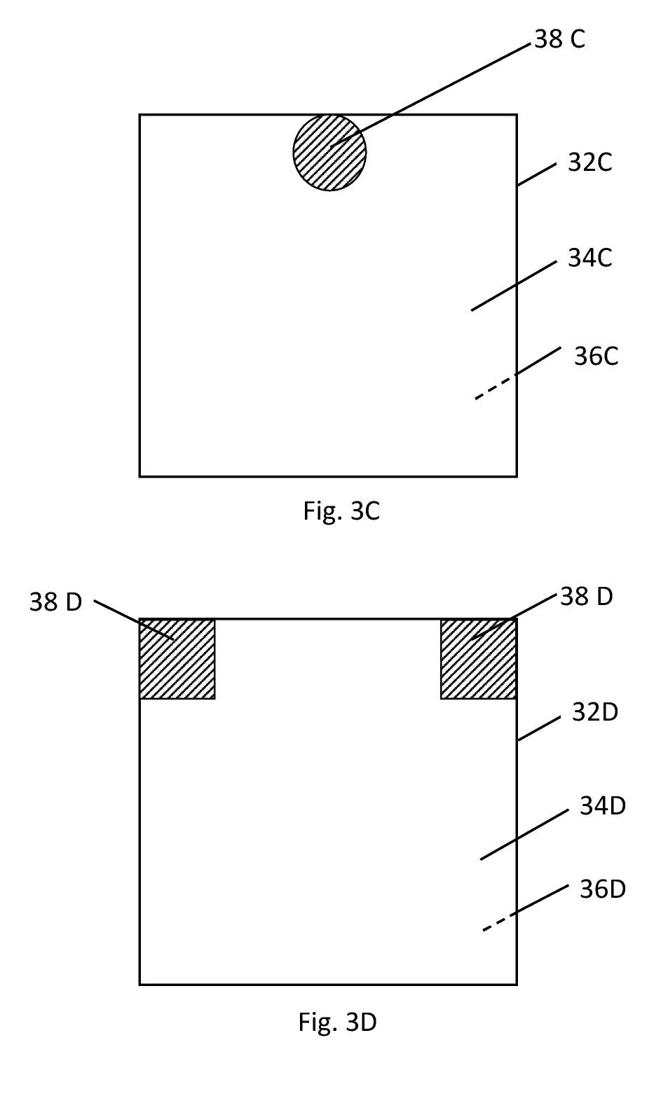

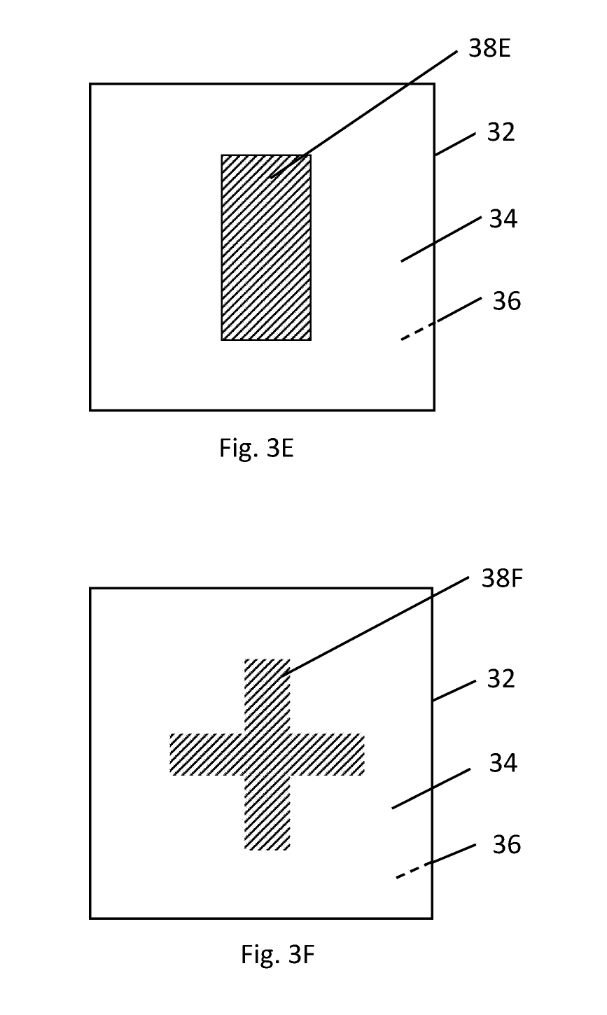

FIGS. 3A, 3B, 3C, 3D, 3E, and 3F are top views showing different embodiments of a sheet with re-adherable area arranged at different places of the sheet.

In FIGS. 3A, 3B, 3C, 3D, 3E, and 3F, reference numerals 32A, 32B, 32C, 32D, 32E, and 32F respectively indicate six different embodiments of a sheet according to the present disclosure. The sheet of each embodiment, i.e., 32A, 32B, 32C, 32D, 32E, and 32F has a first side 34A, 34B, 34C, 34D, 34E, and 34F, respectively and a second side 36A, 36B, 36C, 36D, 36E, and 36F, respectively. The first side 34A, 34B, 34C, 34D, 34E, and 34F, comprises at least one re-adherable area 38A, 38B, 38C, 38D, 38E, and 38F respectively, the re-adherable area allowing the respective sheet to, for multiple times, adhere to a surface and then be removed therefrom.

The at least one re-adherable area may of different shapes. Possible shapes of the re-adherable area can be circle, oval, and any kind of polygon; any other regular shape; and any irregular shape. Possible shapes of the re-adherable area can also be any part of the above regular or irregular shape, such as a part- or half-circle, a part- or half-oval, and the like. For example, in the figures, re-adherable area 38A, 38B, 38D, and 38E are rectangular; 38C is circular; and 38F is a cross.

The at least one re-adherable area may be of different sizes. The re-adherable area may occupy any part of or full area of the first side of the sheet. For example, in the figures, re-adherable area 38A, 38C, 38D, 38 E and 38F occupy only a part or a few parts of the respective sheet while 38B occupies the entire area of the sheet 32B.

The at least one re-adherable area may be provided at any part of the first side of the sheet: along an edge of the sheet, in the center of the sheet, or anywhere else. For example, in the figures, re-adherable area 38A, 38C, and 38D are provided along an edge of the respective sheet; 38B is provided on the entire area of the sheet 32B; 38F is provided in the center of the sheet 32F.

The at least one re-adherable area may comprise a plurality of sub-areas. For example, in the figures, re-adherable area 38D comprises two sub-areas respectively arranged at two corners of the sheet 32D.

Preferably, the at least one re-adherable area is provided with re-adherable adhesive. Preferably, each sheet can be removed from the surface to which it is adhered without leaving residue of the adhesive. Removable microsphere adhesives and pressure sensitive adhesives can facilitate this feature. Using such adhesives for the sheets of the present disclosure, each sheet can be removed from the surface to which it is adhered without leaving any residue, or trace, of the adhesive. This is advantageous as it eliminates, or at least reduces, the cleaning work needed after using the sheet for protecting the surface.

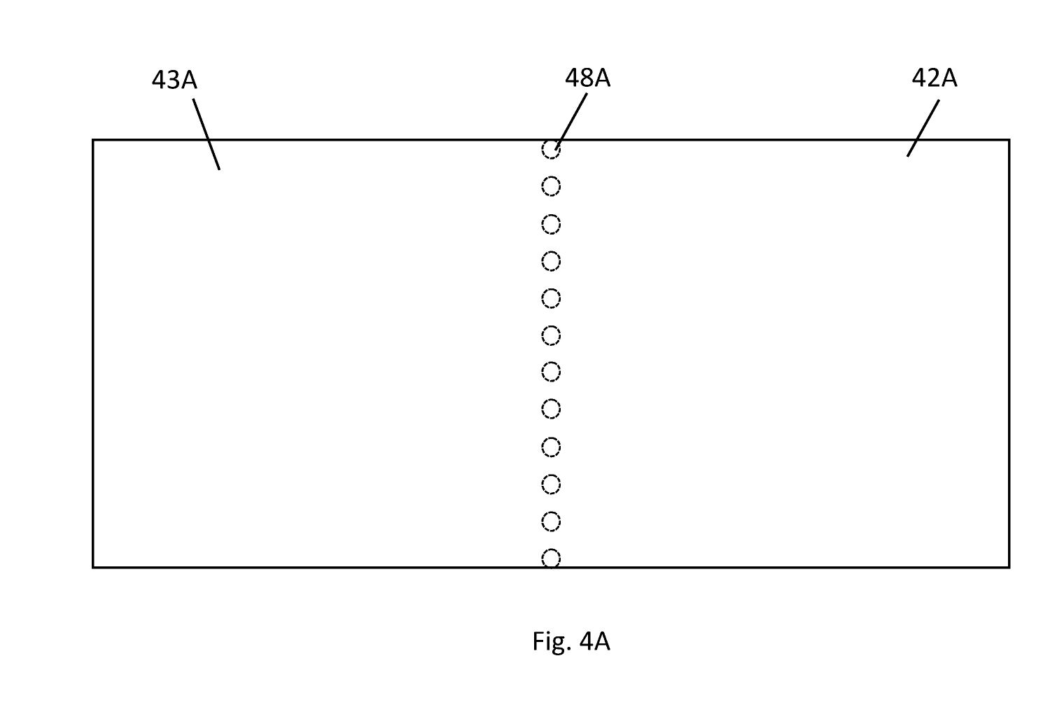

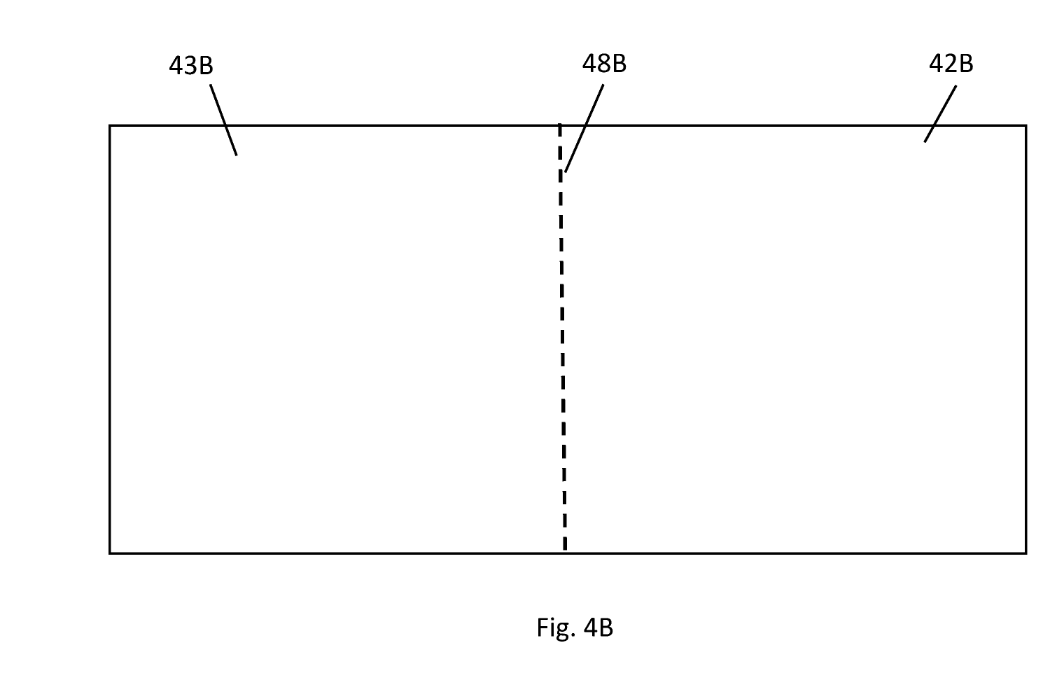

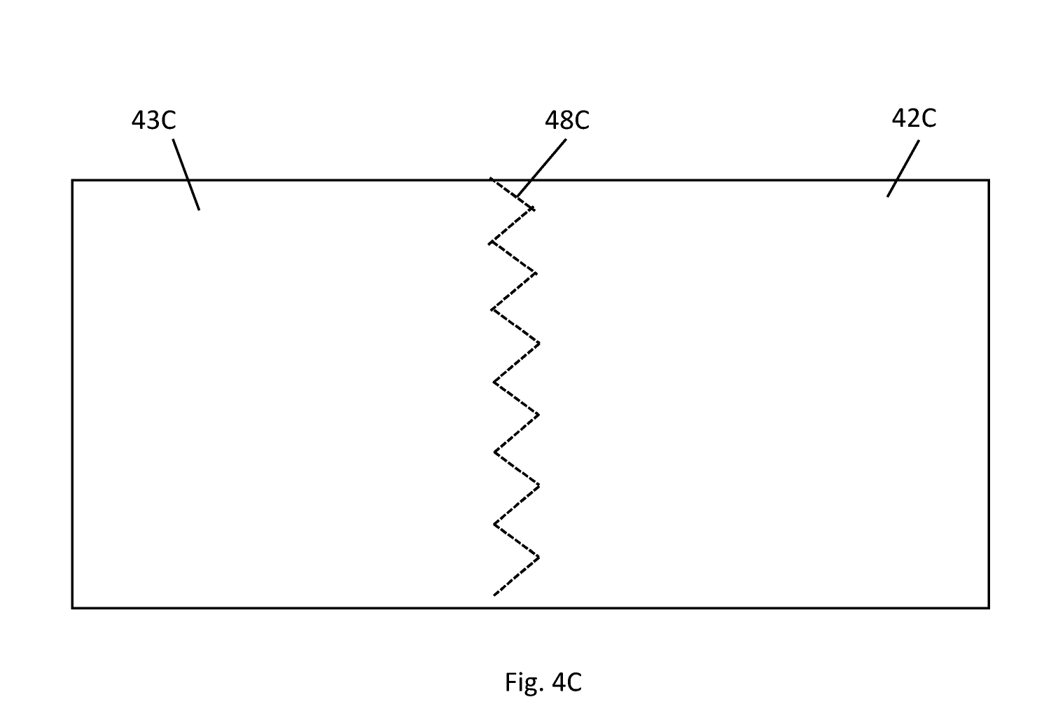

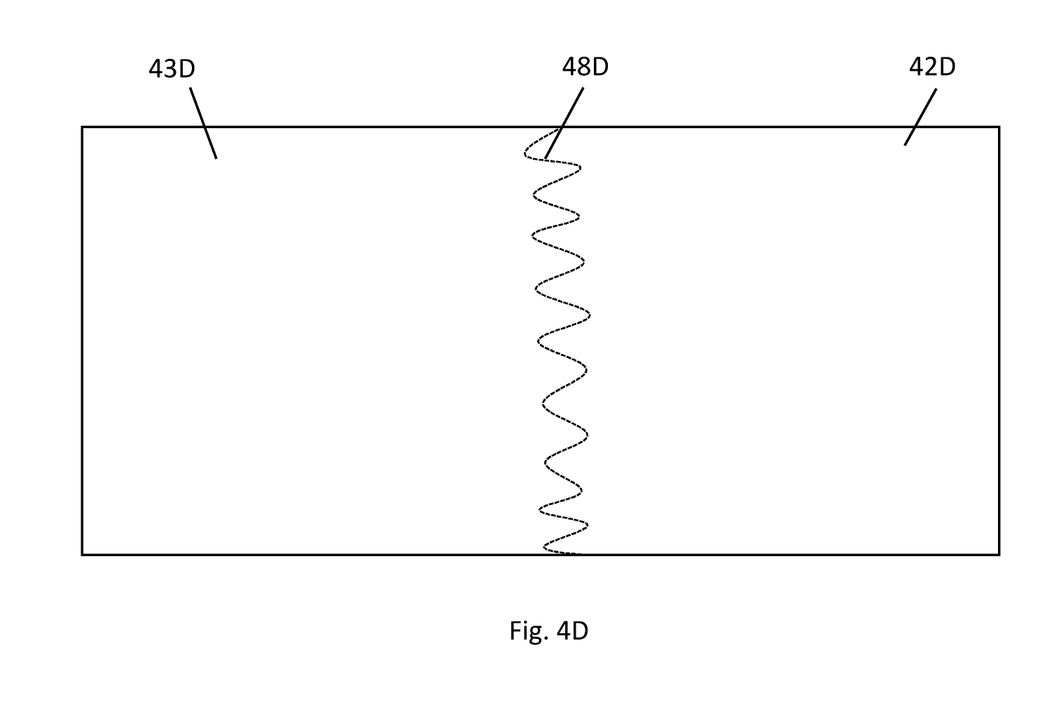

FIGS. 4A, 4B, 4C, and 4D are top views showing different embodiments of a sheet being detachably attached to the sheet immediately next to it.

The product according to the present disclosure comprises a plurality of moisture-resistant sheets arranged in a roll or a stack. In FIGS. 4A, 4B, 4C, and 4D, reference numerals 42A, 42B, 42C, and 42D denote a first sheet in the roll or stack and 43A, 43B, 43C, and 43D denote a second sheet (in the roll or stack) that is immediately next to the sheet 42A, 42B, 42C, and 42D, respectively.

The first sheet 42A, 42B, 42C, and 42D and the respective second sheet 43A, 43B, 43C, and 43D are detachably attached to each other. This kind of attachment is indicated by the dotted line 48A, 48B, 48C, and 48D between the two sheets.

The attachment can take various forms. While certain forms of attachment are realized by a line of perforations or incisions, other forms of attachment are possible. For example, each sheet can be detachably attached to the sheet immediately next to it in the roll or stack through one or more of the following:
1. the at least one re-adherable area that is provided on a first side of the sheet that allows the sheet to, for multiple times, adhere to a surface and then be removed therefrom;
2. one or more perforations provided along at least one edge between said sheet and the sheet immediately next to it;
3. one or more incisions provided along at least one edge between said sheet and the sheet immediately next to it; and
4. one or more weakened provided along at least one edge between said sheet and the sheet immediately next to it parts.

When the attachment is realized by the at least one re-adherable area that is provided on a first sheet, the at least one re-adherable area allows the first sheet to, for multiple times, adhere to a second sheet, that is immediately next to it in the roll or stack, and then be removed therefrom.

With respect to the approach of perforation(s), an embodiment is shown in FIG. 4A. In this figure, the perforations form a line 48A along the left edge of the sheet 42A. In other words, the line 48A is between sheet 42A and the sheet 43A, the sheet immediately next to sheet 42A.

With respect to the approach of incision(s), an embodiment is shown in FIG. 4B. In this figure, the incisions form a straight line 48B along the left edge of the sheet 42B. In other words, the line 48B is between sheet 42B and the sheet 43B, the sheet immediately next to sheet 42B.

With respect to the approach of incision(s), another embodiment is shown in FIG. 4C. In this figure, the incisions form a zigzag line 48C along the left edge of the sheet 42C. In other words, the line 48C is between sheet 42C and the sheet 43C, the sheet immediately next to sheet 42C.

With respect to the approach of incision(s), yet another embodiment is shown in FIG. 4D. In this figure, the incisions form a line, or a course, or progression 48D characterized by round turns first to one side and then to the other. The line 48D is along the left edge of the sheet 42D. In other words, the line 48D is between sheet 42D and the sheet 43D, the sheet immediately next to sheet 42D.

With respect to the approach of weakened part(s), which is not shown in the drawings, each sheet can be detachably attached to a sheet immediately next to it in the roll or stack through one or more weakened parts formed along at least one edge between said sheet and the sheet immediately next to it. Unlike perforations or incisions, weakened part(s) do not necessarily cause penetration of the sheet. For instance, the edge between a particular sheet and the sheet immediately next to it may be made thinner than the other parts of the sheets; hence, this edge can withstand less tear-force such that the two sheets, attached next to each other, can be detached apart from each other along the edge. For another example, the edge between a particular sheet and the sheet immediately next to it may be made of a weaker material than that forming the other parts of the sheets; hence, the edge can withstand less tear-force such that the two sheets, attached next to each other, can be detached apart from each other along the edge.

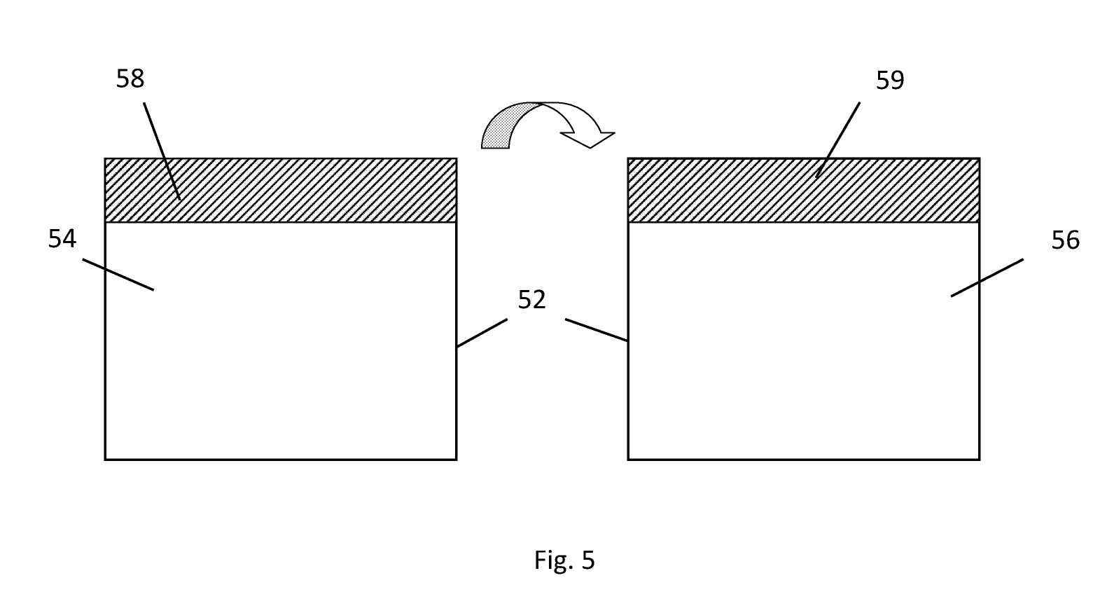

FIG. 5 shows top views of the two sides of a sheet. The sheet is indicated as 52 in the figure. Reference numeral 54 indicates a first side of the sheet 52 while reference numeral 56 indicates a second side of the sheet 52. As discussed above, the second side 56 of the sheet 52 is resistant to moisture, and the first side 54 of the sheet 52 comprises at least one re-adherable area 58 that allows said sheet to, for multiple times, adhere to a surface and then be removed therefrom.

In one embodiment, the first side 54 of the sheet 52 is also resistant to moisture. A user may use either the first side or the second side of the sheet to protect against moisture.

In another embodiment, the second side 56 of each sheet also comprises at least another re-adherable area 59 that allows said sheet 52 to, for multiple times, adhere to a surface and then be removed therefrom.

Having thus described the invention in full detail, it will be understood that such detail need not be strictly adhered to, but that additional changes and modifications may suggest themselves to one skilled in the art, all falling within the scope of the invention as defined by the subjoined claims.

What is claimed is:

1. A product comprising a plurality of moisture resistant sheets of material arranged in a roll or a stack, wherein
each sheet is detachably attached to a sheet immediately next to it in the roll or stack;
each sheet has a first side and a second side, wherein
the first side of each sheet comprises at least one re-adherable area that allows said sheet to, for multiple times, adhere to a surface and then be removed therefrom, and
the second side of each sheet is resistant to moisture such that liquid-containing substance coming into contact with said second side cannot seep through said sheet.

2. The product as recited in claim 1, wherein
when the plurality of sheets of moisture resistant material are arranged in a stack, they are arranged in a spiral bound stack.

3. The product as recited in claim 1, wherein
each sheet is further resistant to oil, fat, and/or grease such that oil, fat, and/or grease that comes into contact with the second side of said sheet cannot seep through said sheet.

4. The product as recited in claim 1, wherein
each sheet is further resistant to any one of the following types of liquid: water, tea, coffee, milk, Kool-Aid, alcohol, alcohol drink, juice, soup, sauce, vinegar, soda, hair dye, liquid soap, liquid detergent, dish wash, fingernail polish, urine, blood, glue, lubricant, liquid type topical medicine.

5. The product as recited in claim 1, wherein
each sheet is further resistant to any one of the following types of partial-liquid/partial-solid substance: honey, yogurt, syrup, gravy, gel, jam, glue, sauce, soup, pancake mix, ice-cream, peanut butter, butter, cream, toothpaste, hand soap, medicine, paint, glue, lubricant, ink, frosting, make-up products, acrylic nail mixture, ointment type topical medicine.

6. The product as recited in claim 1, wherein the at least one re-adherable area is provided with re-adherable adhesive.

7. The product as recited in claim 5, wherein
each sheet can be removed from the surface to which it is adhered without leaving residue of the adhesive.

8. The product as recited in claim 1, wherein
each sheet is detachably attached to the sheet immediately next to it in the roll or stack through one or more of the following:
the re-adherable area, which further allows said sheet to, for multiple times, adhere to the sheet immediately next to it and then be removed therefrom;
one or more perforations along at least one edge between said sheet and the sheet immediately next to it;
one or more incisions along at least one edge between said sheet and the sheet immediately next to it; and
one or more weakened parts along at least one edge between said sheet and the sheet immediately next to it.

9. The product as recited in claim 1, wherein
the first side of each sheet is also resistant to moisture.

10. The product as recited in claim 1, wherein
the second side of each sheet also comprises at least one re-adherable area that allows said sheet to, for multiple times, adhere to a surface and then be removed therefrom.

11. The product as recited in claim 1, wherein
the sheets are made of one or more of the following material:
water-proof paper, RevLar water-proof paper, crepe paper, masking tape, Design Vellum, Bristol Vellum, Flat back paper.

12. The product as recited in claim 1, wherein
the sheets are made of a non-toxic material.

13. The product as recited in claim 1, wherein
the sheets can be cleaned and/or sterilized.

14. Use of the product comprising a plurality of sheets as recited in claim 1 in cooking, food preparation, drink preparation, cleaning, laundering, sanitizing, building, repairing, painting, medical environment, educational environment, and child-care.
